(19) United States
(12) Patent Application Publication
(10) Pub. No.: US 2021/0310405 A1
(43) Pub. Date: Oct. 7, 2021

(54) Thrust Vectoring Ignition Chamber Engine with Two Phase Axial Fuel Intake System

(71) Applicant: Ravi Shankar Gautam, Gaya (IN)

(72) Inventor: Ravi Shankar Gautam, Gaya (IN)

(21) Appl. No.: 17/262,762

(22) PCT Filed: Jul. 25, 2019
(86) PCT No.: PCT/IN2019/050542

§ 371 Date: Jan. 25, 2021

(30) Foreign Application Priority Data
Jul. 25, 2018 (IN) 201821027866

(51) Int. Cl. F02B 53/08; F02B 53/10; F02B 53/12; F02B 55/08; F02B 55/14; F02B 53/06

(52) U.S. Cl. CPC F02B 53/08; F02B 53/10; F02B 53/06; F02B 55/08; F02B 55/14; F02B 53/12

(57) ABSTRACT

This patent discloses thrust vectoring ignition chamber engine in which ignition chamber is an annular cylinder having nozzles mounted such that during fuel suction phase they are sealed and during ignition of fuel they are unsealed so that hot jets of ignited fuel escaping through nozzles cause coupled rotatory motion on the ignition chamber. Engine uses specially designed dwell barrel cam mechanism for two phase suction and compression of fuel which facilitates the separation of fuel valve from ignition chamber. Flywheel mounted on extension of ignition chamber functions as output of the engine. Timing of electrically controlled nozzle seal and fuel valve can be adjusted so that each half rotation of flywheel completes three phases namely fuel/air suction, compression and combustion, instead of two rotations as required in engine according to prior art. This engine can give improved power boost by firing for every half revolution.

### FIELD OF INVENTION

The present disclosure relates generally to engine which can use petrol, diesel, compressed natural gas etc as fuel.

### BACKGROUND OF INVENTION

Automobiles have played significant role in enhancing human civilization by transporting agricultural products, construction material to build better homes etc. In automobile engines we need output which can rotate wheels. All automobile engines consist of cylindrical ignition chamber in which a piston is slip fit and is allowed to move back and forth at cylinder's rear end. Fuel-air mixture that ignition chamber received from an inlet valve (located at front end) is compressed and ignited to cause sudden expansion of gas which in turn causes thrust to the piston forcing in move rearwards. Connecting rods connecting the piston to crank shaft helps to convert translation motion of piston to rotatory motion of crankshaft which in turn causes flywheel (that is axially attached to crankshaft) to rotate. Flywheel causes wheel of automobile to rotate via transmission mechanism. One cycle of a four stroke engine for generating thrust from fuel consists of four phases namely fuel-air mixture suction, fuel-air mixture compression, ignition via spark plug (that causes thrust) and exhaust of burnt gas through exhaust valve located on the front end of ignition chamber. Each phase requires one strokes of piston and hence one cycle involves two rotations of crankshaft and therefore flywheel.

Around two centuries prior to the invention of modern day internal combustion chamber engine described above, two inventors Marcus Vitruvius Pollio (c. 80 BCE-c. 15 CE) from Rome and Hero (c. 10-70 CE) from Alexandria (Greece) had independently conceived of a steam engine named Aeolipile which was based on principle of thrust vectoring of steam enclosed in a chamber through transversely oriented nozzles. Automobile engine according to this invention is based on thrust vectoring concept which can also be seen in action in garden sprinkler, Catherine wheel, fighter jets etc.

### Technical Problem

One of the drawbacks of four stroke engine is one phase of exhaust of burnt fuel gas is unproductive.

One of the drawbacks of four stroke engine is that it requires conversion of translation motion to rotatory motion for compression of fuel-air mixture as well as rotation of crankshaft.

One of the drawbacks of four stroke engine is that moving parts like inlet valves and exhaust valve comes in contact with ignited fuel gas mixture due to which it requires overhaul and maintenance. For example unmaintained valves may cause fuel backfire etc.

One of the drawbacks of four stroke engine is that it requires complex process and lot of moving parts to operate cam mechanisms for operating inlet and exhaust valves.

One of the drawbacks of two stroke engine is that exhaust gas and fuel gets mixed which causes lot of pollution.

### SUMMARY OF INVENTION

One of the objectives is to provide an engine which can directly convert fuel thrust to rotatory motion. This is achieved by thrust vectored exit of ignited fuel-air mixture. Ignited fuel-air mixture is bound to escape through pair of angled nozzles located at diametrically opposite sides of ignition chamber. Nozzles are angled with each nozzle making an acute angle with respect to outward radial direction. Difference between angles that nozzles make with the line joining them is 180 degree so that the exhaust of gas cause coupled torque on the ignition chamber.

In the engine, according to this invention, piston based compression mechanism have been retained to achieve high compression.

In the engine, according to this invention, timing of electrically controlled nozzle seal and fuel valve can be adjusted so that each half rotation of flywheel completes three phases namely fuel/air suction, compression and combustion, instead of two rotations as required in engine according to prior art. Thus this engine can achieve improved power boost whenever required.

Engine, according to this invention, do not require a separate phase for exhaust of burnt gas and do not cause mixing of exhaust gas with fuel as well.

Engine, according to this invention, uses specially designed dwell barrel cam mechanism for two phase suction and compression of fuel which facilitates the separation of fuel valve from ignition chamber.

In the engine, according to this invention, involves a novel method to securely operate dwell barrel cam mechanism for suction and compression of fuel using sleeve gear.

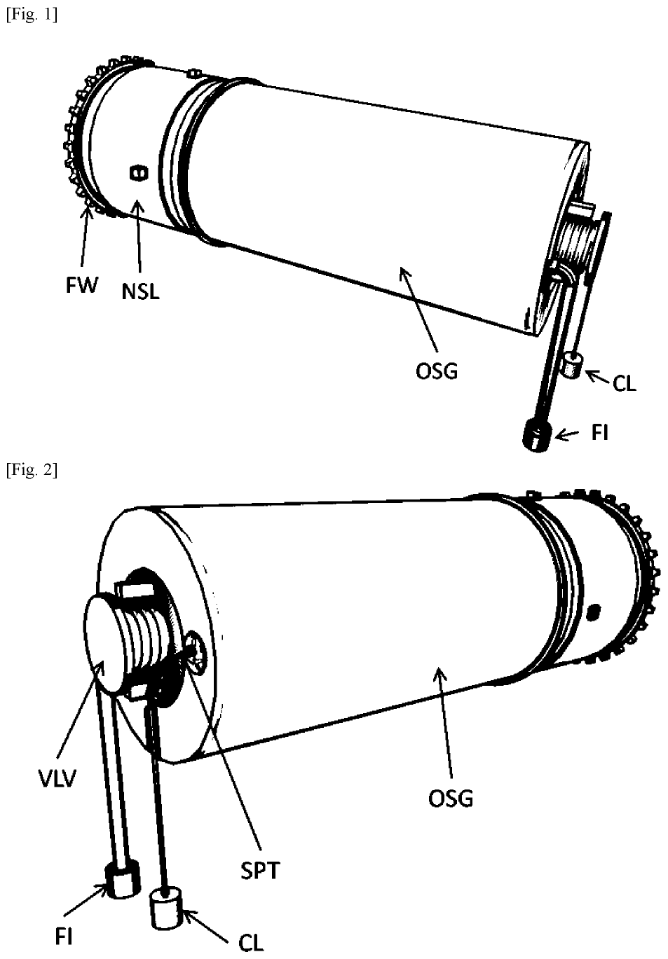

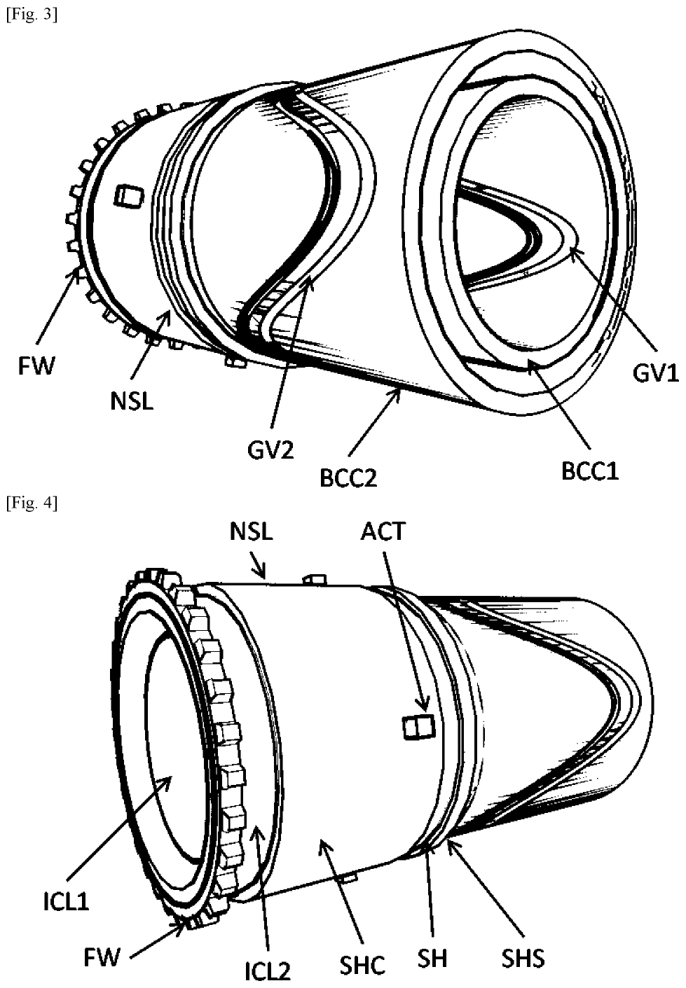

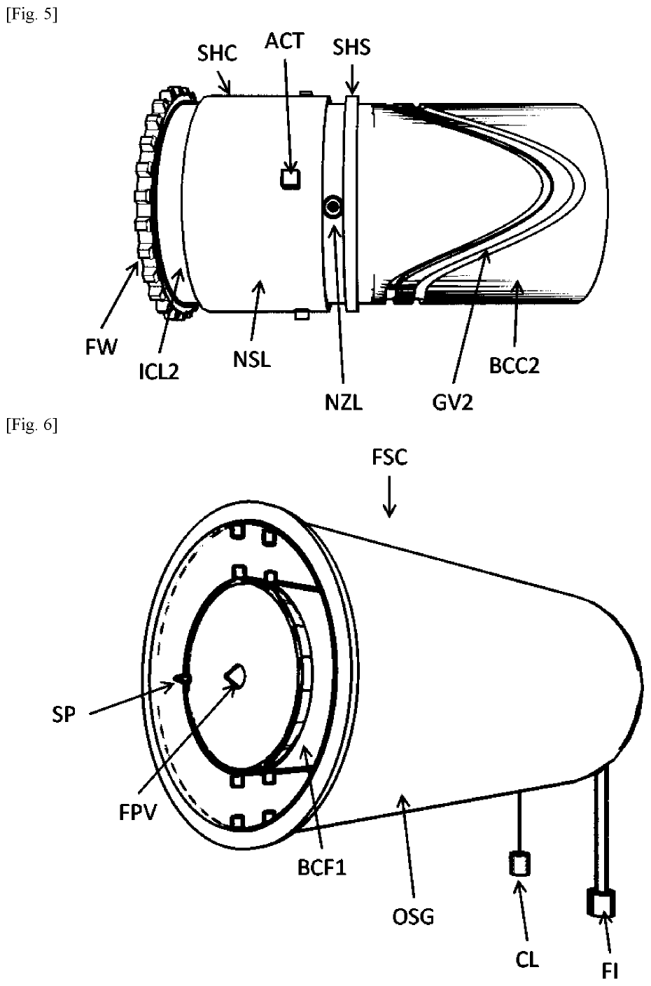

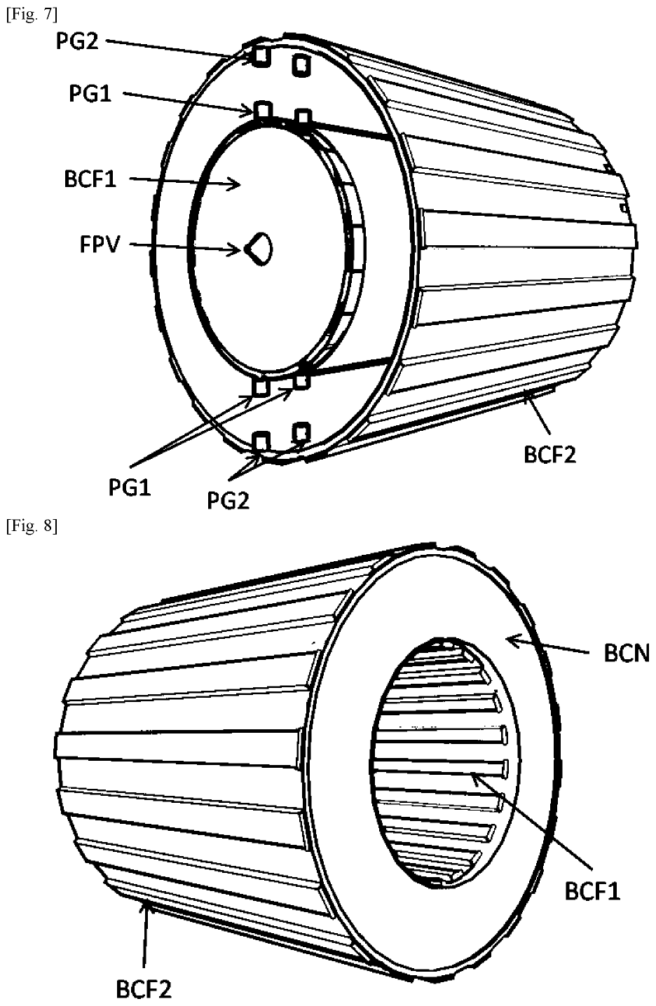

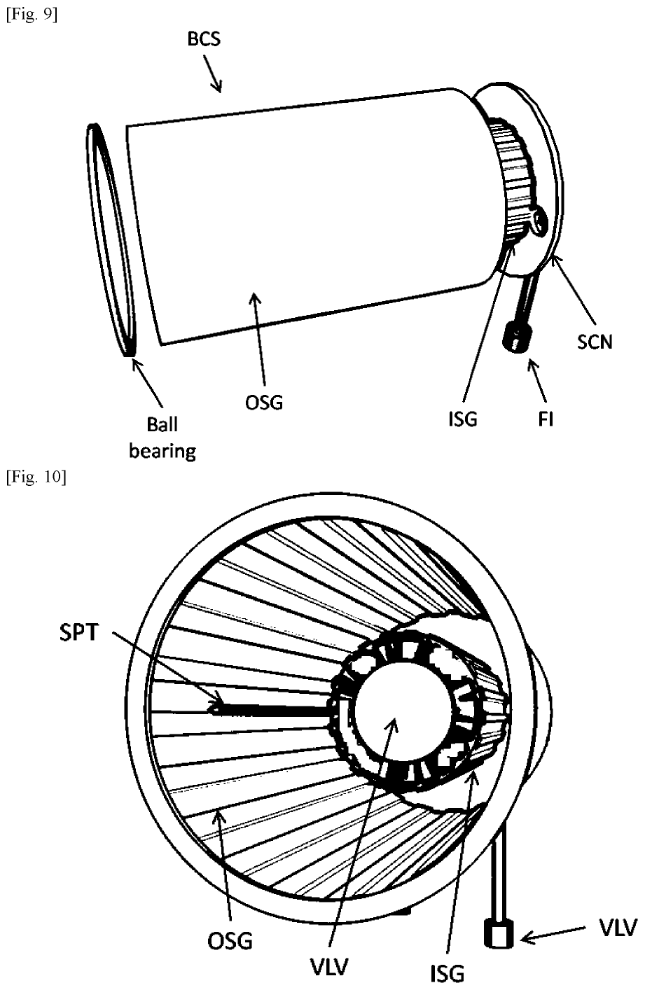

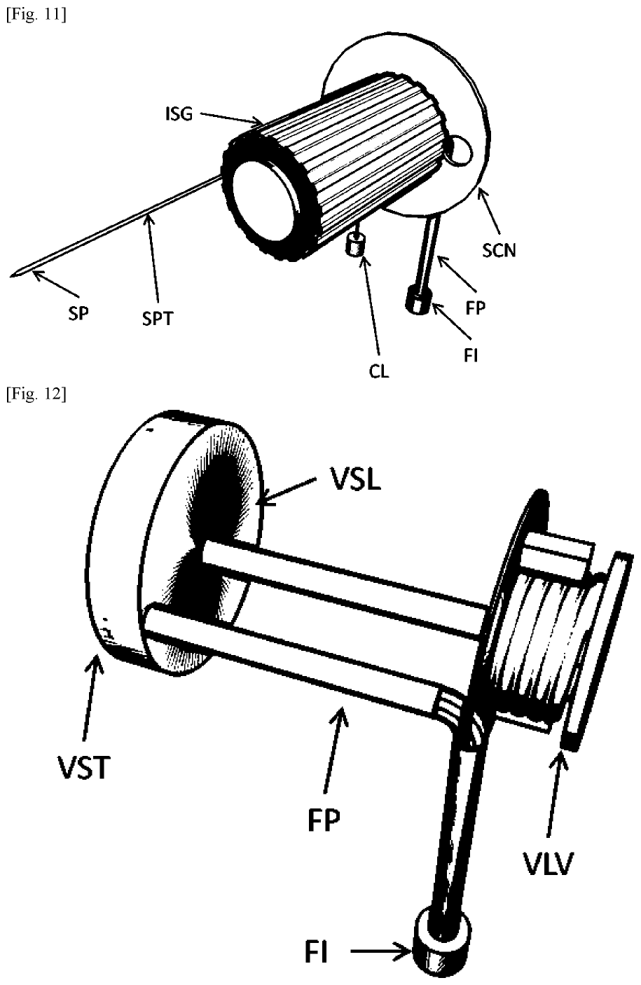

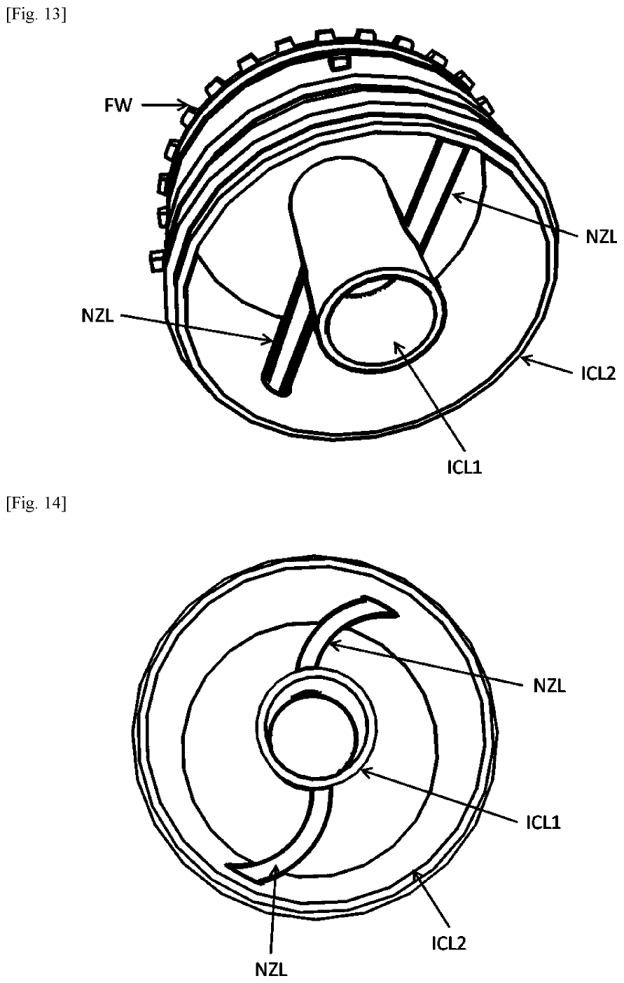

### BRIEF DESCRIPTION OF DRAWINGS

[FIG. 1] Side view of barrel cam based thrust vectoring ignition chamber engine with electrically controlled nozzle seal according to this invention

[FIG. 2] Rear view of barrel cam based thrust vectoring ignition chamber engine according to this invention

[FIG. 3] Rear view of outer and inner barrel cam cylinders with two coaxially parallel dwell barrel cam grooves.

[FIG. 4] Side view of outer barrel cam cylinder with two coaxially parallel dwell barrel cam grooves and sealed nozzle

[FIG. 5] Side view of outer barrel cam cylinder illustrating two coaxially parallel dwell barrel cam grooves and unsealed nozzle.

[FIG. 6] Front view of fuel suction and compression system and also illustrating spark plug tube extending out rear side of inner sleeve gear.

[FIG. 7] and [FIG. 8] Front and rear view of inner and outer barrel cam follower mechanism with barrel cam connector

[FIG. 9] Exploded view of barrel cam support mechanism illustrating outer sleeve gear, inner sleeve gear, front ball bearing and sleeve gear connector.

[FIG. 10] Front view of barrel cam support mechanism illustrating spark plug tube extending out front side of inner sleeve gear.

[FIG. 11] Front view of inner sleeve gear mounted with fuel valve and sleeve gear connector illustrating spark plug tube extending out front side of inner sleeve gear.

[FIG. 12] Side view of fuel valve.

[FIG. 13] Nozzle as pair of right conical tubes.

[FIG. 14] Nozzle as pair of curved tubes.

### DESCRIPTION OF EMBODIMENTS

Referring to [FIG. 1], the preferred embodiment of an automobile engine (1) according to this invention is shown to include an engine enclosure (ENC), thrust vectoring ignition chamber (IC), fuel suction and compression system (FSC), fuel delivery and ignition mechanism (FDI), nozzle seal (NSL), and flywheel (FW).

Engine enclosure (ENC) appropriately secures all parts of engine, provides support to engine via rectangular slabs attached to outer static parts of engine like nozzle seal and outer sleeve gear of fuel suction and compression system and provides exit to the burnt fuel gas via exhaust pipe.

Thrust vectoring ignition chamber (IC), as shown in [FIG. 4] and [FIG. 5], consists of a pair of coaxial annular cylinders, an inner annular cylinder (ICL1) and an outer annular cylinder (ICL2), connected coaxially via coaxial rings (IR), and coupled thrust vectoring nozzle (NZL) wherein
inner annular cylinder (ICL1) is coaxially fixedly caped at its front side by ignition chamber seal (ICS), which is a circular disk;
fuel suction and compression system (FSC) is mounted on rear side of the ignition chamber followed towards rear side by fuel delivery and ignition mechanism (FDI); coupled thrust vectoring nozzle (NZL), as shown in FIG. 13, is a pair of conical tubes mounted at diametrically opposite points on the right circular section on the middle part of ignition chamber by passing through holes on the inner annular cylinder (ICL1) and outer annular cylinder (ICL2) such that one end with bigger aperture opens inside the inner annular cylinder (ICL1) and other end with smaller aperture opens on the outer side of outer annular cylinder (ICL2);
each tube make equal acute angle with respect to radially outward direction in opposite direction along the right circular section of ignition chamber;
surface of the nozzles on the outer side of ignition chamber are cut to take the shape of outer surface of the outer annular cylinder (ICL2) so that ignition chamber can glide inside the nozzle seal cylinder smoothly and surface of the nozzles on the inner side of ignition chamber are cut to take the shape of inner surface of the inner annular cylinder (ICL1).

Nozzle seal (NSL), as shown in [FIG. 4] and [FIG. 5], which dynamically puts nozzle (NZL) into closed or open phase, consists of three annular cylinders, namely shutter cavity (SHC), shutter (SH) and shutter stopper (SHS), coaxially mounted on outer side of outer cylinder of ignition chamber near nozzle (NZL) and a push-pull solenoid actuator (ACT), wherein
shutter cavity (SHC) is a special type of annular cylinder, whose front portion coaxially holds the outer annular cylinder of ignition chamber (ICL2) with the help of a ball bearing but the rear portion (which is facing nozzle) forms an annular cylindrical cavity with outer annular cylinder of ignition chamber (ICL2) which can house shutter (SH);
shutter (SH) is an annular cylinder coaxially mounted to the rear portion of the shutter cavity (SHC) such that outer annular cylinder of ignition chamber (ICL2) slip fits inside the shutter (SH) and shutter (SH) can be operated by actuator (ACT) to slide in and out of cylindrical annular cavity on the rear portion of shutter cavity (SHC) to unseal and seal the nozzles (NZL) respectively;
shutter stopper (SHS) is an annular cylinder located on the rear side of nozzles (NZL), which coaxially holds the outer annular cylinder of ignition chamber (ICL2), via one or more coaxial ball bearings and to helps to stop shutter (SH) from sliding away; push-pull actuator (ACT) consists of three-four solenoid coils mounted on the outer side shutter cavity (SHC), which operates the shutter (SH) and works to push and pull the shutter (SH) to slide in and slide out of the cylindrical annular cavity on the rear portion of shutter cavity (SHC);
shutter cavity (SHC), and shutter stopper (SHS) are secured to enclosure (ENC) by rectangular slabs.

Fuel suction and compression system (FSC), as shown in [FIG. 6], which is designed for suction, compression and combustion of fuel-air mixture inside the ignition chamber, consists of inner barrel cam mechanism (IBC) and outer barrel cam mechanism (OBC), barrel cam connector (BCN), barrel cam support mechanism (BCS).

Inner barrel cam mechanism (IBC) consists of inner barrel cam cylinder (BCC1), inner barrel cam follower (BCF1) wherein
inner barrel cam cylinder (BCC1), as shown in [FIG. 3], an annular cylinder with inner and outer radius equal to that of inner cylinder of ignition chamber, is coaxially attached to it as latter's extension and has two coaxially parallel dwell cam grooves with each groove having two peaks, two troughs and two dwells with each dwell extending a trough point into a groove of shape of a circular arc;
inner barrel cam follower (BCF1), as shown in [FIG. 7] and [FIG. 8], an annular cylinder having outer radius equal to the inner radius of inner barrel cam cylinder (BCC1), having two pair of pegs with one pair located at diametrically opposite side to that of the other, is slip fit into inner barrel cam cylinder (BCC1) such that front and rear peg of each pair falls in the front cam groove and rear cam groove respectively;
inner barrel cam follower (BCF1) is open at its rear end and sealingly capped at its front end, with a front opening pressure valve mounted on center of the cap.

Outer barrel cam mechanism (OBC) consists of outer barrel cam cylinder (BCC2), outer barrel cam follower (BCF2) wherein
outer barrel cam cylinder (BCC1), as shown in [FIG. 3], [FIG. 4] and [FIG. 5], an annular cylinder with inner and outer radius equal to that of outer cylinder of ignition chamber, is coaxially attached to it as latter's extension and has two coaxially parallel dwell cam grooves with each groove having two peaks, two troughs and two dwells with each dwell extending a trough point into a groove of shape of a circular arc;
outer barrel cam follower (BCF2), as shown in [FIG. 7] and [FIG. 8], an annular cylinder, with an inner radius equal to the outer radius of outer barrel cam cylinder (BCC2), having two pair of pegs attached at former's inner surface, with one pair located at diametrically opposite side to that of the other, is slip fit into outer barrel cam cylinder (BCC2) such that front and rear peg of each pair falls in the front cam groove and rear cam groove respectively;
additionally outer barrel cam follower (BCF2), has a longitudinal teeth on its outer surface so that it can be meshingly engaged with sleeve gear of barrel cam support mechanism, as its hub gear;
inner side of outer barrel cam follower (BCF2), as shown in [FIG. 8], at its rear end is coaxially connected via Barrel cam connector (BCN), a coaxial annular circular disk, to the outer side of inner barrel cam follower (BCF1) at latter's rear end.

Barrel cam support mechanism (BCS), as shown in [FIG. 9], [FIG. 10] and [FIG. 11], consists of a outer sleeve gear (OSG), inner sleeve gear (ISG), sleeve gear connector (SCN), wherein
outer sleeve gear (OSG), is a sleeve gear with internal teeth, of length greater than double the length of outer barrel cam follower (BCF2), is mounted coaxially on latter's outer side with its front end coaxially attached to the rear end of nozzle seal cylinder (NSL);
longitudinal teeth on the inner surface of outer sleeve gear (OSG) meshingly engages with longitudinal teeth of outer surface of outer barrel cam follower (BCF2); inner sleeve gear (ISG), is a sleeve gear with external teeth, of length approximately equal to the length of inner barrel cam follower (BCF1), and outer radius equal to the inner radius of the inner barrel cam follower with its rear end coaxially attached to the rear end of outer sleeve gear via a sleeve gear connector (SCN);
sleeve gear connector (SCN), a circular annular plate, have a circular hole on its annular face for the passage of spark plug tube (SPT);
positioning and length of inner sleeve gear is such that during compression phase, when front end of inner barrel cam follower (BCF1) is closest to the nozzle, longitudinal teeth on the outer surface of inner sleeve gear (ISG) slip fits into and meshingly engages with longitudinal teeth of inner surface of inner barrel cam follower (BCF1) and during suction phase, when front end of inner barrel cam follower (BCF1) is farthest from the nozzle, front end cap and rear end of inner barrel cam follower (BCF1) doesn't touch the front end of inner sleeve gear and sleeve gear connector (SCN), respectively.

Fuel delivery and ignition mechanism, as shown in [FIG. 11] and [FIG. 12], consists of air-fuel valve (VLV), fuel-air pipe (FP), fuel injector (FI), spark plug (SP), ignition coil (CL) wherein
air-fuel valve (VLV), a push to open valve operated by a solenoid coil, is housed in inner sleeve gear which works as fuel valve deck, and front end of inner sleeve gear (which is located at the rear end of inner cam follower (BCF1)) works as valve seat;
fuel-air pipe (FP), a pipe extending out of the fuel injector is inserted into the rear portion of inner cam follower (BCF1) on the front side of valve seal;
wire emanating from solenoid coil of valve is connected to the battery;
spark plug (SP) is housed in spark plug tube (SPT) where spark plug tube, as shown in [FIG. 10] and [FIG. 11], is a tube of length double the length of inner cam follower (BCF1) whose rear portion is longitudinally attached to the inner sleeve gear (ISG) along ridge between a pair of teeth on the right side of outer surface of inner sleeve gear (ISG) and front half portion extends along a longitudinal ridge (created by removing one or more teeth) on the inner wall of inner cam follower (BCF1) and with a small portion at its front end protruding out of a hole on the front cap of inner cam follower (BCF1); so that spark plug tube is slip fit into the said hole;
spark plug is located in the front portion of spark plug tube such that electrode of former is exposed towards nozzle (NZL) inside the ignition chamber;
wires emanating from the rear end of spark plug is housed in spark plug tube and extends out of rear end of spark plug tube to connect to the ignition coil (CL).

Flywheel (FW), an externally teethed annular gear, that functions as an output of the engine, is connected coaxially to the front side extension of outer cylinder of ignition chamber.

Thrust vectored ignition chamber engine described above is an engine which can use petrol as fuel and in order to use diesel as a fuel we need to replace spark plug (SP) with pressure valve, ignition coil (CL) with fuel source, air-fuel valve with air valve.

According to another variation to above description, thrust vectoring nozzle (NZL), as shown in FIG. 14, consists of pair of curved conical tubes so that escape angle of gas at outer surface of outer cylinder (ICL2) of ignition chamber can be closer to tangent of circle described by nozzles with aperture of nozzles inside the inner cylinder (ICL1) of ignition chamber, is along radial direction.

Engine Operation for Stationary Nozzle Seal

Each half rotation of ignition chamber and therefore flywheel is completes a cycle of three phases namely suction phase, compression phase and combustion phase occurring in serial order.

In suction phase nozzles are in closed state, fuel valve is in closed state, and barrel cam follower pin is moving from trough to peak of the cam groove forcing barrel cam follower to move away from the nozzle. In compression phase nozzles are in closed state, fuel valve is in open state and barrel cam follower pin is moving from peak to trough of the cam groove forcing barrel cam follower to move towards the nozzle. In combustion phase nozzles are in open state, fuel valve is in open state and barrel cam follower pin is moving dwell part of the cam groove forcing barrel cam follower to stay at the dead end. Air suction into ignition chamber takes place in two phases. In the first phase, which coincides with compression phase of the engine, when barrel cam moves towards the nozzle, fuel valve is in open state and fuel get sucked in space inside inner barrel cam follower annular cylinder and at the same time air-fuel in the ignition chamber gets compressed. In the second phase, which coincides with suction phase of the engine, when barrel cam moves away from the nozzle and fuel valve is in closed state, fuel stored in space inside inner barrel cam follower, gets forced into ignition chamber through pressure valve.

During combustion phase nozzles of the ignition chamber are in open state and compressed air-fuel mixture is ignited due to which hot air gushes out of the nozzles to cause coupling torque action resulting in rotatory thrust on the ignition chamber. As soon as half rotation is complete the nozzles come in closed state. A separate phase to expell burnt gas is not required. During suction phase half of spark-plug tube is exposed inside the inner annular cylinder of the ignition chamber which again gets enclosed during compression phase.

During suction and compression phase inner and outer sleeve gears provides support to as well as constraints the inner and outer barrel cam followers to move only in longitudinal direction.

1. A barrel cam based rotary automobile engine with reciprocating fuel suction and compression system with two phase fuel compression system, for directly converting the fuel energy to rotatory motion using thrust vectoring of ignited fuel, consisting of an engine enclosure, thrust vectoring ignition chamber, fuel suction and compression system, fuel delivery and ignition mechanism, nozzle seal and flywheel.

2. Engine enclosure, claimed in claim 1, appropriately secures all parts of engine, provides support to engine via rectangular slabs attached to outer static parts of engine like nozzle seal and outer sleeve gear of fuel suction and compression system, claimed in claim 1, and provides exit to the burnt fuel gas via exhaust pipe.

3. Thrust vectoring ignition chamber, claimed in claim 1, consists of a pair of coaxial annular cylinders, an inner annular cylinder and an outer annular cylinder, connected coaxially via coaxial rings, and coupled thrust vectoring nozzle wherein
inner annular cylinder is coaxially fixedly caped at its front side by ignition chamber seal which is a circular disk;
fuel suction and compression system is mounted on rear side of the ignition chamber followed towards rear side by fuel delivery and ignition mechanism;
coupled thrust vectoring nozzle is a pair of conical tubes mounted at diametrically opposite points on the right circular section on the middle part of ignition chamber by passing through holes on the inner annular cylinder and outer annular cylinder such that one end with bigger aperture opens inside the inner annular cylinder and other end with smaller aperture opens on the outer side of outer annular cylinder;
each tube make equal acute angle with respect to radially outward direction in opposite direction along the right circular section in middle portion of ignition chamber;
surface of the nozzles on the outer side of ignition chamber are cut to take the shape of outer surface of the outer cylinder so that ignition chamber can glide inside the nozzle seal cylinder smoothly and surface of the nozzles on the inner side of ignition chamber are cut to take the shape of inner surface of the inner annular cylinder.

4. Nozzle seal, claimed in claim 1, which dynamically puts nozzle into closed or open phase, consists of three annular cylinders, namely shutter cavity, shutter and shutter stopper, coaxially mounted on outer side of outer cylinder of ignition chamber near nozzle and a push-pull solenoid actuator, wherein
shutter cavity is a special type of annular cylinder, whose front portion coaxially holds the outer annular cylinder of ignition chamber with the help of a ball bearing but the rear portion (which is facing nozzle) forms an annular cylindrical cavity with outer annular cylinder of ignition chamber which can house shutter;
shutter is an annular cylinder coaxially mounted to the rear portion of the shutter cavity such that outer annular cylinder of ignition chamber slip fits inside the shutter and shutter can be operated by actuator to slide in and out of cylindrical annular cavity on the rear portion of shutter cavity to unseal and seal the nozzles respectively;
shutter stopper is an annular cylinder located on the rear side of nozzles, which coaxially holds the outer annular cylinder of ignition chamber, via one or more coaxial ball bearings and to helps to stop shutter from sliding away;
push-pull actuator consists of three-four solenoid coils mounted on the outer side of shutter cavity, which operates the shutter and works to push and pull the shutter to slide in and slide out of the cylindrical annular cavity on the rear portion of shutter cavity;
push-pull actuator is timed in a way that it put the nozzle in open state only at the end of ignition phase when compressed fuel gas is ignited and raised to a sufficient pressure to cause considerable rotary thrust upon exit through nozzle and put the nozzle in closed state after the ignited gas has exited through nozzle;
shutter cavity, and shutter stopper are secured to engine enclosure by rectangular slabs.

5. Fuel suction and compression system, claimed in claim 1, which is designed for suction, compression and combustion of air-fuel mixture inside the ignition chamber, consists of inner barrel cam mechanism and outer barrel cam mechanism, barrel cam connector, barrel cam support mechanism.

6. Inner barrel cam mechanism, claimed in claim 5, consists of inner barrel cam cylinder, inner barrel cam follower wherein
inner barrel cam cylinder, an annular cylinder with inner and outer radius equal to that of inner cylinder of ignition chamber, is coaxially attached to it as latter's extension and
inner barrel cam cylinder has two coaxially parallel dwell cam grooves with each groove having two peaks, two troughs and two dwells with each dwell extending a trough point into a groove of shape of a circular arc;
inner barrel cam follower an annular cylinder having outer radius equal to the inner radius of inner barrel cam cylinder, having two pair of pegs with one pair located at diametrically opposite side to that of the other, is slip fit into inner barrel cam cylinder such that front and rear peg of each pair falls in the front cam groove and rear cam groove respectively and
inner barrel cam follower is open at its rear end and sealingly capped at its front end, with a front opening pressure valve mounted on center of the cap.

7. Outer barrel cam mechanism, claimed in claim 5, consists of outer barrel cam cylinder, outer barrel cam follower wherein
outer barrel cam cylinder, an annular cylinder with inner and outer radius equal to that of outer cylinder of ignition chamber, is coaxially attached to it as latter's extension and
has two coaxially parallel dwell cam grooves with each groove having two peaks, two troughs and two dwells with each dwell extending a trough point into a groove of shape of a circular arc;
outer barrel cam follower an annular cylinder, with an inner radius equal to the outer radius of outer barrel cam cylinder, having two pair of pegs attached at former's inner surface, with one pair located at diametrically opposite side to that of the other, is slip fit into outer barrel cam cylinder such that front and rear peg of each pair falls in the front cam groove and rear cam groove respectively;
additionally outer barrel cam follower, has a longitudinal teeth on its outer surface so that it can be meshingly engaged with sleeve gear of barrel cam support mechanism, as its hub gear;
inner side of outer barrel cam follower at its rear end is coaxially connected via Barrel cam connector, a coaxial annular circular disk, to the outer side of inner barrel cam follower at latter's rear end.

8. Barrel cam support mechanism, claimed in claim 5, consists of a outer sleeve gear, inner sleeve gear, sleeve gear connector wherein
outer sleeve gear, is a sleeve gear with internal teeth, of length greater than double the length of outer barrel cam follower, is mounted coaxially on latter's outer side with its front end coaxially attached to the rear end of nozzle seal cylinder;
longitudinal teeth on the inner surface of outer sleeve gear meshingly engages with longitudinal teeth of outer surface of outer barrel cam follower;
inner sleeve gear, is a sleeve gear with external teeth, of length approximately equal to the length of inner barrel cam follower, and outer radius equal to the inner radius of the inner barrel cam follower with its rear end coaxially attached to the rear end of outer sleeve gear via a sleeve gear connector;
sleeve gear connector, a circular annular plate, have a circular hole on its annular face for the passage of spark plug tube;
positioning and length of inner sleeve gear is such that during compression phase, when front end of inner barrel cam follower is closest to the nozzle, longitudinal teeth on the outer surface of inner sleeve gear slip fits into and meshingly engages with longitudinal teeth of inner surface of inner barrel cam follower and during suction phase, when front end of inner barrel cam follower is farthest from the nozzle, front end cap and rear end of inner barrel cam follower doesn't touch the front end of inner sleeve gear and sleeve gear connector, respectively.

9. Fuel delivery and ignition mechanism, claimed in claim 1, consists of air-fuel valve, fuel-air pipe, fuel injector, spark plug, ignition coil wherein
air-fuel valve, a push to open valve operated by a solenoid coil, is housed in inner sleeve gear which works as fuel valve deck, and front end of inner sleeve gear (which is located at the rear end of inner cam follower, claimed in claim 1) works as valve seat;
fuel-air pipe, a pipe extending out of the fuel injector is inserted into the rear portion of inner cam follower on the front side of valve seal;
wire emanating from solenoid coil of valve is connected to the battery;
spark plug is housed in spark plug tube where spark plug tube is a tube of length double the length of inner cam follower whose rear portion is longitudinally attached to the inner sleeve gear along ridge between a pair of teeth on the right side of outer surface of inner sleeve gear and front half portion extends along a longitudinal ridge (created by removing one or more teeth) on the inner wall of inner cam follower and with a small portion at its front end protruding out of a hole on the front cap of inner cam follower so that spark plug tube is slip fit into the said hole;
spark plug is located in the front portion of spark plug tube such that electrode of former is exposed towards nozzle inside the ignition chamber;
wires emanating from the rear end of spark plug is housed in spark plug tube and extends out of rear end of spark plug tube to connect to the ignition coil.

10. Flywheel, claimed in claim 1, an externally teethed annular gear that functions as an output of the engine, is connected coaxially to the front side extension of outer cylinder of ignition chamber.

11. Thrust vectored ignition chamber engine described above is an engine which can use petrol as fuel and in order to use diesel as a fuel we need to replace spark plug with pressure valve, ignition coil with fuel source, air-fuel valve with air valve.

12. According to another variation to above description, thrust vectoring nozzle consists of pair of curved conical tubes so that escape angle of gas at outer surface of outer annular cylinder of ignition chamber can be closer to tangent of circle described by nozzles with aperture of nozzles inside the inner annular cylinder of ignition chamber, is along radial direction.
